(19) United States
(12) Patent Application Publication
(10) Pub. No.: US 2007/0062394 A1
(43) Pub. Date: Mar. 22, 2007

(54) Thermoset printing blanket

(76) Inventor: John Damewood, Spartanburg, SC (US)

Correspondence Address: CLEMENTS WALKER, 1901 ROXBOROUGH ROAD, SUITE 300, CHARLOTTE, NC, 28211, US

(21) Appl. No.: 11/229,971

(22) Filed: Sep. 19, 2005

(51) Int. Cl. B41N 10/04

(52) U.S. Cl. 101/376

(57) ABSTRACT

A printing blanket carcass, comprising a fabric stack substrate comprising at least one fabric ply. Each ply has a plurality of warp and fill fibers or yarns. A compressible layer comprising a moisture cured thermoset polymer matrix is deposed on top of the substrate. The compressible layer contains a plurality of closed cells distributed substantially uniformly therein such that said layer has substantially uniform compression characteristics. A top fabric stack, comprising at least one fabric ply each of said ply having plurality of warp and fill fibers or yarns, is then deposed atop the thermoset compressible layer.

### FIELD OF THE INVENTION

The invention relates to a method for producing a multi-layer printing blanket such as an offset lithography blanket wherein the carcass of the blanket is made substantially from a thermoset material. An elastomeric printing surface is coated or laminated to the carcass containing the thermoset material. Microspheres can be incorporated into the thermoset carcass in order to provide compressibility to the blanket.

### BACKGROUND OF THE INVENTION

The use of blankets in printing techniques, such as, offset lithography, is well known, wherein such blankets have a primary function of transferring ink from a printing plate to paper. Such printing blankets are very carefully designed so that the blanket is not damaged, either by mechanical contact with the press or by chemical reaction with the ink ingredients or other solvents used in the printing process. Repeated mechanical contacts do cause a certain amount of compression of the blanket, however, integrity of the blanket must be maintained within acceptable limits so that the image is properly reproduced. It is also important that the blanket has rebound characteristics such that it is capable of eventually returning to its original thickness, and that it provide image transfer of a constant quality.

Multilayer polymeric printing blankets can be broadly described as having two subcomponent layers: the printing face, and the carcass. The printing face layer is the portion of the blanket that transfers ink from plate to paper, etc. The carcass is the total construction lying beneath the face layer. In order to create a carcass that can withstand the stresses of the printing process, a number of polymeric coatings and textile layers are required. The carcass generally requires at least two woven fabrics, each having multiple coatings of polymeric material thereon, to be pressed together to form a unit. The polymeric material may include microspheres therein to make the construction compressible. A face coat or face stock, which is the printing stock, is applied to the uppermost layer of fabric. This whole process might take 15 or 20 coating passes through a polymeric laminating machine, plus 3 or 4 layers of fabric.

A key to obtaining a printing blanket having the desired compressibility, stress, and resiliency is in providing a compressible layer therein. In particular, it is generally known that by including at least one layer of material comprising a fabric reinforced compressible layer of resilient polymer in a printing blanket, that printing problems such as those described above, as well as “blurring” (i.e., a lack of definition), caused by a small standing wave in the blanket printing surface adjacent to the nip of the printing press, can be avoided. Such compressible layer also can serve to absorb a “smash”, that is, a substantial deformation in the blanket caused by a temporary increase in the thickness in the material to be printed due to, for example, the accidental introduction of more than one sheet of paper during the printing operation. By incorporating a compressible layer in the blanket, a “smash” can be absorbed without permanent damage to the blanket or impairment of the printing quality of the blanket. In addition, a resilient, compressible layer helps to maintain the evenness of the printing surface and the thickness of the blanket during the printing operation by restoring the normal thickness of the blanket after compression at the nip of the press.

Blankets of the type described above suffer from a variety of deficiencies, however, which negatively affect their durability and print quality. For example, they are susceptible to wicking of ink, water and solvents commonly used in a press room, through either the exposed cut edges of the blankets or, in instances where these edges are protected by the application of a sealant, directly through cracks in the blanket or the bottom ply of the fabric. Waters, solvents, and inks that wick through to the under layers of the blanket can react with or cause deterioration to the adhesives bonding the various layers of the blanket together. At best, this can result in a bubbling of the printing blanket, leading to decreased print quality and lower printing speeds due to an imbalance created in the blanket. At worst, the wicking can cause delamination of the blanket, which can result in substantial damage to the printing apparatuses and large downtimes.

It would therefore be highly desirable to create a printing blanket that does not require as many polymeric layers and laminations, while still retaining the desired stress characteristics of the multilayer blanket. It would also be desirable if this blanket were resistant to solvent and other chemicals to resist delamination of the blanket. It is also environmentally desirable to eliminate as many of the volatile solvents. It would further be desirable to manufacture these blankets at a lower cost than that required by the multi-layer, multi-laminated blankets currently known in the art.

### DESCRIPTION OF THE PRIOR ART

U.S. Pat. No. 6,645,601 issued to Serain et al., describes a printing blanket that includes at least one thermoplastic elastomer layer. This layer can be made of polyurethane.

U.S. Pat. No. 6,071,620 issued to Kuczynski et al., discloses a lithographic layer for a printing blanket. The lithographic layer (i.e., the printing surface) is a layer of thermoplastic material, which ensures maximum transfer of the printing ink from the blanket cylinder to the paper. The thermoplastic is preferably polyurethane or ethylene-propylene that has been polarized through the incorporation of additional ingredients, such as ethylene vinyl acetate, mineral loading, plastifier, and pigments.

U.S. Pat. No. 6,027,789 issued to Canet et al., discloses a printing surface for a printing blanket. A substrate beneath the printing surface is disclosed, that can be made of a hydrophobic or hydrophilic elastomeric material such as formulated polyolefin or polyurethane.

U.S. Pat. No. 5,974,974 issued to Agnew et al., discloses a printing blanket, wherein the printing layers are formed from elastomeric polymers formed via photopolymerization. The polymer can be polyurethane.

U.S. Pat. No. 5,549,68 issued to Byers et al., discloses a printing blanket, wherein the traditional compressible layer can be eliminated by incorporating an impregnated compressible fabric. The impregnated fabric can consist of thermoset polymers having microspheres therein.

U.S. Pat. No. 5,487,339 issued to Breventani et al., discloses a method of attaching a holding bar to a printing blanket, wherein a strip of thermoplastic or thermoset hot melt material such as polyurethane or nylon is used to attach the holding bar to the printing blanket.

U.S. Pat. No. 5,389,171 issued to Bartholmei et al., discloses a method of making a printing blanket where the outer cover layer (i.e., the printing layer) is preferably made of elastic cured polymers such as polyurethane.

U.S. Pat. No. 5,352,507 issued to Bresson et al., discloses a seamless multilayer printing blanket, wherein the resiliently compressible layer comprises a foamed elastomeric material such as polyurethane that can be reinforced with fibers.

U.S. Pat. No. 4,303,721 issued to Rodriguez discloses closed cell foam printing blanket, wherein the compressible layer can include polyurethane.

U.S. Pat. No. 4,174,244 issued to Thomas et al., discloses a method of making a printing blanket, wherein the cover, or top printing layer, may comprise any material having rubbery or compressible properties, which will cure and, optionally, foam under the conditions of molding. Examples of acceptable material include polyurethane.

U.S. Pat. No. 3,983,287 issued to Goosen et al., discloses a printing blanket, wherein the resilient layer contains polyurethane.

Additional objects and advantages of the invention will be set forth in part in the description that follows, and in part will be obvious from the description, or may be learned by the practice of the invention. The objects and advantages of the invention may be realized and attained by means of instrumentalities and combinations particularly pointed out in the appended claims.

### SUMMARY OF THE INVENTION

Generally, elastomers are any elastic materials having properties similar to rubber. They can be stretched tremendously and will typically return to their pre-stretched shape without deformities. This pliability is due to elastomers' glass transition temperatures (T_{g}) being at or below room temperature. Furthermore, an elastomer's molecules are typically unoriented, but will readily align to an oriented arrangement upon stretching.

In contrast to elastomers, thermoplastics are generally rigid, having a T_{g} above room temperature, but will fuse or soften when heated, and harden again when cooled. Both thermoplastics and elastomers can be molded and shaped when heated above their respective T_{g}. Processing methods for thermoplastic products thus involves heating and applying pressure to the material in order to reach its T_{g}. The materials can then be extruded or molded into their desired shapes.

A thermoset is completely different from an elastomer or moldable thermoplastic. Thermoset polymers are crosslinked to such an extent that they “set” into a given shape when first made, and cannot be shaped or molded later when heated to their T_{g}. Rather, the thermoset will decompose upon heating past its T_{g}. They are typically hard, strong, and brittle, but they may soften slightly when heated to below their T_{g}. Because of this extensive crosslinking, the thermoset is very resistant to interactions with other chemicals, as well as high temperatures and abrasions. It is therefore often utilized as a coating or adhesive in order to prevent corrosion of the underlying materials. Phenolic, melamine, resorcinol formaldehyde, furan, polyester, polyimide and urea formaldehyde resins are thermosetting adhesives that offer strong bonds and good resistance to high temperatures.

The blanket of the present invention utilizes a thermoset material in the carcass of the printing blanket, and can be manufactured in a variety of ways. Thermoset material can be used in any or all of the layers, depending on the desired properties. The thermoset material can comprise a single large compressible layer with microspheres therein. Additionally, the thermoset material can be utilized as an adhesive between fabric layers. In one specific embodiment, the thermoset material containing microspheres to form the compressible layer is applied to the reinforcing fabric base. A top fabric is then laminated onto the compressible layer for additional support, followed finally by the face stock over that. In one specific embodiment, the blanket is comprised of two-ply base layer fabric, a compressible thermal set polyurethane or polyurea layer atop the two-ply base layer, and a top fabric.

### BRIEF DESCRIPTION OF THE DRAWING

FIG. 1 is a greatly enlarged cross-sectional view of the invented multilayer printing blanket.

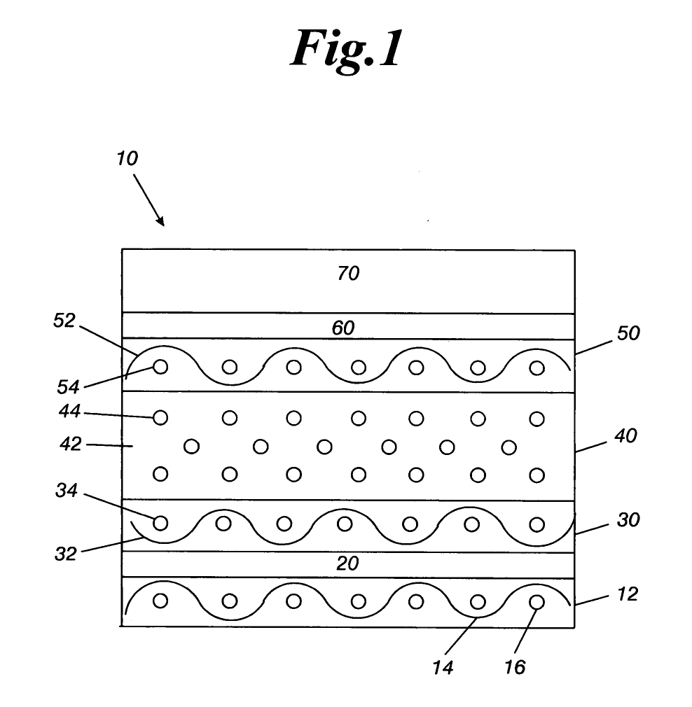

### DETAILED DESCRIPTION

The fabric substrate 12 is comprised of at least one fabric ply, having warp fibers 14 and fill fibers 16, which are formed of natural or synthetic material. These fibers are woven and produced from spun or filament yarn of the desired length. Cotton, polyester, nylon, rayon, etc. are typical materials which may be used as fibers or yarns of the fabric substrate 12.

Preferably, the warp fibers 14 are formed from natural material such as cotton, whereas the fill fibers 16 are comprised of a synthetic textile (e.g., polyester). Both the warp and fill fibers or yarns should have a tensile strength of at least 30 psi. The substrate preferably has a yarn count per inch ranging between about 55-61 (warp) and 57-63 (fill). The fabric substrate ranges between about 5.8 to 6.2 ounces/sq. yd. in weight and from 0.014 to 0.016 inches in thickness (also referred to as “gauge”). The warp direction has a tensile strength of at least about 150 pounds/inch, whereas that of the fill direction is at least about 60 pounds/inch. Moreover, in the preferred embodiment, the fabric substrate should be capable of no more than about 1.9% residual stretch.

In general, in the fabric plys used in the present invention, the fiber or yarn counts per inch for both warp or fill directions can vary between 20 and 150, depending upon the denier of the fiber or yarn. Moreover, fabric weights of 2 to 8, preferably about 4 to 8, ounces per square yard and thicknesses of 0.005 to 0.03″ can be utilized for particular applications of the various fabric plys of this invention.

Fabric substrate 12 is additionally spread coated, calendared, dipped, or otherwise contacted upon only its upper surface with an adhesive material 20. Suitable adhesive materials include thermoplastic resins, thermosetting resins, polyurethanes, and natural or synthetic elastomers. PVC and other polyolefins are suitable thermoplastic resins, while polyurethanes are preferred.

Suitable adhesives include those of the acrylonitrile, neoprene, and acrylic families. Polysulfides, alone or in combination with acrylonitrile or neoprene, can also be used. Any natural or synthetic elastomer can be used if desired, and such materials are preferred for use with the invention.

Preferably, the adhesive can be a thermoset resin, most preferably a thermoset polyurethane or polyurea. The preferred viscosity for the matrix material ranges between about 10,000 to 25,000 cps.

Moisture-cure polyurethanes are formed with resins having terminal isocyanate NCO groups in the molecule. They are normally a single-package polyurethane prepolymer. Following application, the prepolymer or the isocyanate group reacts with moisture in the atmosphere to form the final cross-linked coating.

These are generally low molecular weight, linear polymers, with isocyanate end groups. Such isocyanate-terminated prepolymers can be produced by reacting an excess of polyisocyanate with high molecular weight hydroxyl polyester or polyether polyols.

The isocyanate end-groups react with any compound containing an active hydrogen, such as alcohols, amines, or other polyurethanes and ureas. For moisture curing systems, the active hydrogen is provided by atmospheric moisture. Thus, the relative humidity will effect the speed at which the system cures.

The reaction is a two stage process where water first reacts with the isocyanate groups to produce an amine and carbon dioxide. The amine will then react with other isocyanate groups to form a urea until all available isocyanates are consumed. Carbon dioxide that is generated diffuses through the film and is then evaporated from the system. The reactions can be summarized as follows:
—NCO+H2O→—NH2+CO2
—NCO+—NH2→—NH—CO—NH
—NCO+—NH—CO—NH→—NH—CO—NH—CO—N

The adhesive material used with the fabric plys may additionally contain a plurality of cells therein. These cells, either closed or open, are similar to the formation of the compressible layer, described infra.

Located directly above the adhesive 20, and bonded thereto, is fabric 30 comprising at least one fabric ply. Fabric plies of fabric 30 are similar in many respects to fabric substrate 12 discussed above in that the plies of fabric 30 are comprised of warp fibers 32, and fill fibers 34, respectively, formed of natural or synthetic material. These fibers, as in the case of substrate 12, are woven and are comprised of spun or filament yarn of the desired length. Preferably, the warp fibers are formed from natural material such as cotton, whereas the fill fibers are comprised of a synthetic textile (e.g., polyester). Both the warp and fill fibers or yarns should have a tensile strength of at least about 30 psi.

In a preferred embodiment, plies of fabric 30 have a yarn count per inch ranging between about 75-80 (warp) and 53-58 (fill). Fabric 30 ranges in weight between about 4.9 to 5.3 ounces/sq. yd. The thickness, i.e., gauge, of fabric 30 ranges between about 0.0105 and 0.0115 inch. The warp fibers 32 have a tensile strength of at least about 150 pounds/inch. The tensile strength of fill fibers 32 is at least about 40 pounds per inch. Fabric 30 should be capable of no more than about 2.2% residual stretch.

Located above the fabric 30 is compressible layer 40. Compressible layer 40 is made from a suitable resilient thermoset polymer matrix 42, into which a quantity of cell-forming materials, or microspheres 44, are evenly dispersed to form a compound. The polymer matrix can be a material similar to that used in adhesive layer 20, including acrylonitrile, neoprene, and acrylic families. Polysulfides, alone or in combination with acrylonitrile or neoprene, can also be used. Preferably, the polymer matrix is a thermoset resin, most preferably a thermoset polyurethane or polyurea. The preferred viscosity for the matrix material ranges between about 50,000 to 60,000 cps.

Generally, the microspheres are formed from materials such as, i.e., thermoplastic resins, thermosetting resins, and phenolic resins. The microspheres range in diameter between about 1-200 and preferably 50-130 microns, with an average size of about 90 microns being most preferred. They are dispersed relatively uniformly throughout the matrix material such that, upon application of the matrix to the fabric ply, they become thoroughly embedded in its interstices. Thus, when applied, the microsphere loaded material described herein will substantially impregnate the fabric substrate on its upper side.

The microspheres are uniformly distributed throughout the elastomer in such a way to avoid any appreciable crushing of the microspheres. Additionally, the microspheres are incorporated in the elastomeric material at a loading of about 1-20% by weight and preferably 1-10% of the solid contents. This percentage will vary based on such factors as microsphere dimension, wall thickness, extent of any crosslinking and bulk density, or if blowing agents are additionally incorporated within the matrix.

To form the cells in the embodiment described above, any of a wide variety of microspheres 44 can be added to a solution or dispersion of the matrix 42. If solvent solutions are utilized, the selected microspheres must be resistant to chemical attack from the solvents.

Several acceptable types of thermoplastic microspheres for use with the present invention are marketed, for example, by Expancel and Dualite. Microspheres of a thermoplastic resin are preferred for this embodiment.

If desired, the microspheres may further include a coating thereon to prevent them from aglomerating. Any one of a variety of coatings thereupon, such as talc, calcium carbonate, zinc oxide, titanium dioxide, mica, calcium sulfate, barium sulfate, antimony oxide, clay, silica, and aluminum trihydrate may be used. Improper selection of the sphere/coating can interfere with the desirable properties of the matrix, which can adversely effect polymerization thereof.

Preferably, the urethane compressible layer 40 of the present invention is a hot-melt, moisture-cured system similar to that of adhesive 20, and does not utilize a solvent carrier. It can therefore be applied without the repetitive layer passes inherent in the prior art. The compressible layer 40 can be applied as a single layer, which can be applied in excess of 0.04 inches in a single pass. In blankets typical of the prior art, the compressible layer is formed by depositing a number of thin layers onto a fabric in successive applications to build up the desired thickness. This is necessary to afford efficient volatizing of solvent from the coated elastomer without forming voids in the compressible layer. Thus, preparation and curing time for the blanket has been drastically reduced.

Compressible layer 40 may be adhered to fabric 30 with, for example, the use of a layer of a suitable adhesive (not shown). The particular adhesive will depend upon the specific elastomers utilized to form the plys. Preferably, compressible layer 40 is bonded directly to fabric 30, without the use of additional adhesives.

Located above the compressible layer 40 is a top fabric 50 comprising at least one fabric ply. Fabric 50 can then be bonded to compressible layer 40 with the use of a suitable adhesive such as those described above. Preferably, fabric 50 is nipped directly into the compressible layer 40, alleviating the need for an adhesive.

Fabric plies of the top fabric 50 are similar in many respects to fabric substrate 12 discussed above in that the plies of fabric 50 are comprised of warp fibers 52 and fill fibers 54, respectively, formed of natural or synthetic material. These fibers, as in the case of substrate 12, are woven and comprised of spun or filament yarn of the desired length. Both the warp and fill fibers or yarns should have a tensile strength of at least about 30 psi.

In a preferred embodiment, plies of fabric 50 have a yarn count per inch ranging between about 100-105 (warp) and 77-82 (fill). The fabric used to form 50 ranges in weight between about 3.7 and 3.9 ounces/sq. yd. The thickness, i.e., gauge, of top ply 50 ranges between about 0.008 and 0.010 inch. The warp direction of top ply 50 has a tensile strength of at least about 70 pounds per inch. The tensile strength in the fill direction of ply 50 is at least about 60 pounds per inch. In top fabric ply 34, the stretch of the fabric may range between about 6 and 10%.

Bonded to the upper portion of fabric 50 is elastomeric subface 60 formed from a high durometer, high tensile, low elongation compound (i.e., in comparison to the material used to form the printing face, as described below), which is preferably a compounded nitrile rubber. Alternately, however, a variety of water and solvent based elastomeric compounds, well known in the art, may be used instead of nitrile rubber in forming the subface. Subface 60 is provided to re-enforce the printing face, thus resulting in improved blanket life and resistance to cutting while in use.

Elastomeric printing face 70, adapted to accept the print image from the printing plate and transfer it to, e.g., a paper substrate, is the uppermost layer on laminated/coated blanket 10. In prior art blankets, the application of the elastomeric printing face is typically carried out by the well known method of knife over roll spreading in which a solvated elastomeric compound is spread in numerous successive passes, applying a thickness of about 0.001″ with each pass, over, e.g., a subface or upper fabric layer. Moreover, as pointed out above, in comparison to the material used to form the subface, the elastomeric material used to form the printing face is lower in durometer and tensile strength and higher in elongation.

In addition, printing blankets of the type described above are typically provided with a roughened surface profile in an effort to reduce dot gain, while maintaining good release properties for the blanket. Such roughness profiles have, in the past, been produced either by molding during cure, or by buffing the cured face with medium or coarse grit sandpaper, which is well known in the art. The surface profile is thereafter measured by, e.g., a device known as a profilometer (manufactured by the Perthen Corporation), which is also well known in the art. The surface profiles of prior art laminated blanket printing faces typically have a roughness average (i.e., “RA”) of 1.0 to 1.8 microns while cast blankets, which do not have good release properties, typically have an RA of 0.3 to 0.5 microns. In this regard, it is important to note that the higher the roughness average, the worse the print quality becomes due to decreasing uniformity of the dots.

In blanket 10 of the present invention, however, the roughness average of printing face 70 is adjusted to above about 0.6 microns but below about 0.95 microns, and preferably between about 0.7 to 0.9 microns by buffing with fine sandpaper. The advantage of this treatment is that it affords excellent release properties to the blanket while also resulting in an improved structure of the printed dots, thus providing both improved print quality and releasability to the blanket of the invention. This effect may also be achieved by a number of alternate methods well known in the art, such as molding.

### EXAMPLES

### Example 1

The adhesive was conditioned in an oven at 85° C. for 2 hours prior to coating. The samples were prepared by coating S/4195 (base-ply) with the shown sample at 0.010 inch K/R gap setting. S/4200 (middle-ply) was then nipped/laminated to the coated base-ply. The samples were allowed to cure for 24 hours.

The polyurethane composition was heated at 120° C. for two hours. The carcass middle layer was then coated with the shown PU composition at 0.035 inch K/R gap setting. Top layer S/4232 was then laminated into the hot adhesive. The sample was allowed to cure for 72 hours.

The following PUs were supplied:

| | Viscosity (cps) | % Microspheres |
|---|---|---|
| Composition # | @ 100° C. | (by weight) |
| A (SG 15 16-31) | 29400 | 2.0 |
| B (SG 15 16-32) | 43600 | 2.5 |
| C (SG 15 16-33) | 34200 | 3.0 |

| | |
|---|---|
| D (SGH 0005-3A) | SGH0005-3A |

Viscosity was measured with a Brookfield TT-100 inline viscometer. Gauge was measured with a Cady deadweight bench micrometer, or Cady Gauge. E130-095AD microspheres manufactured by Dualite were utilized in the compressible polyurethane layer. The following blanket carcasses were made utilizing the provided compositions, and obtaining the following results:

| | | Compressible | | Stress |
|---|---|---|---|---|
| Carcass # | Adhesive Layer | Layer | Gauge | (Kg/cm²) |
| 1 | D (SGH 0005-3A) | A (SG 1516-31) | 0.049 | 50.1 |
| 1 | D (SGH 0005-3A) | A (SG 1516-31) | .051 | 40.6 |
| 2 | D (SGH 0005-3A) | B (SG 1516-32) | 0.051 | 45.1 |
| 2 | D (SGH 0005-3A) | B (SG 1516-32 | .050 | 39.0 |
| 3 | D (SGH 0005-3A) | C (SG 1516-33) | 0.051 | 35.3 |
| 3 | D (SGH 0005-3A) | C (SG 1516-33) | .051 | 34.3 |

### Example 2

The adhesive was conditioned in an oven at 120° C. for 2 hours prior to coating.

The samples were prepared by coating S/4195 (base-ply) with the shown sample at 0.010 inch K/R gap setting. S/4200 (middle-ply) was then nipped/laminated to the coated base-ply. The samples were allowed to cure for 24 hours.

The polyurethane composition was heated at 120° C. for two hours. The carcass middle layer was then coated with the shown PU composition at 0.045 inch K/R gap setting. Top layer S/4232 was then laminated into the hot adhesive. The sample was allowed to cure for 96 hours.

The compressible layer PU contained Dualite E130-095AD microspheres.

The following PUs were supplied:

| | Viscosity (cps) | | % Microspheres |
|---|---|---|---|
| Composition # | @ 100° C. | Open-time (sec.) | (by weight) |
| A (SG 1516-137) | 12200 | 24 | 0 |
| B (SG 1516-138) | 11270 | 55 | 0 |
| C (SG 1516-144) | 23950 | 60 | 0 |
| D (SG 1516-148) | 65000 | 10 | 6 |
| E (SG 1516-149) | 62800 | 30 | 6 |

Viscosity was measured with a Brookfield TT-100 inline viscometer. Gauge was measured with a Cady deadweight bench micrometer, or Cady Gauge. E130-095AD microspheres manufactured by Dualite were utilized in the compressible polyurethane layer.

The following blanket carcasses were made utilizing the provided compositions, and obtaining the following results:

| | | Compressible | | Stress |
|---|---|---|---|---|
| Carcass # | Adhesive Layer | Layer | Gauge | (Kg/cm²) |
| 1 | A (SG 1516-137) | D (SG 1516-148) | 0.0555 | 29.69 |
| 2 | A (SG 1516-137) | E (SG 1516-149) | 0.0555 | 29.56 |
| 3 | B (SG 1516-138) | D (SG 1516-148) | 0.0555 | 28.64 |
| 4 | B (SG 1516-138) | E SG 1516-149) | 0.0590 | 26.31 |
| 5 | C (SG 1516-144) | D (SG 1516-148) | 0.0540 | 25.21 |
| 6 | C (SG 1516-144) | E (SG 1516-149) | 0.0530 | 27.21 |

### Example 3

The adhesive was conditioned in an oven at 120° C. for 2 hours prior to coating. The samples were prepared by coating S/4195 (base-ply) with the shown sample at 0.010 inch K/R gap setting. S/4200 (middle-ply) was then nipped/laminated to the coated base-ply. The samples were allowed to cure for 24 hours.

The polyurethane composition was heated at 120° C. for two hours. The carcass middle layer was then coated with the shown PU composition at 0.045 inch K/R gap setting. Top layer S/4232 was then laminated into the hot adhesive. The sample was allowed to cure for 96 hours.

The following PUs were supplied:

| | Viscosity (cps) | | % Microspheres |
|---|---|---|---|
| Composition # | @ 100° C. | Open-time (sec.) | (by weight) |
| A (SG 1516-148) | 65000 | 10 | 6 |
| B (SG 1516-149) | 62800 | 30 | 6 |

Viscosity was measured with a Brookfield TT-100 inline viscometer. Gauge was measured with a Cady deadweight bench micrometer, or Cady Gauge. E130-095AD microspheres manufactured by Dualite were utilized in the compressible polyurethane layer. The following blanket carcasses were made utilizing the provided compositions, and obtaining the following results:

| | | Compressible | | Stress |
|---|---|---|---|---|
| Carcass # | Adhesive Layer | Layer | Gauge | (Kg/cm²) |
| 1 | A (SG 1516-148) | A (SG 1516-148) | 0.055 | 20.28 |
| 2 | B (SG 1516-149) | B (SG 1516-149) | 0.055 | 22.89 |

### Example 4

The adhesive was conditioned in an oven at 120° C. for 2 hours prior to coating. The samples were prepared by coating S/4195 (base-ply) with the shown sample at 0.010 inch K/R gap setting. S/4200 (middle-ply) was then nipped/laminated to the coated base-ply. The samples were allowed to cure for 24 hours.

The polyurethane composition was heated at 120° C. for two hours. The carcass middle layer was then coated with the shown PU composition at 0.045 inch K/R gap setting. Top layer S/4232 was then laminated into the hot adhesive. The sample was allowed to cure for 96 hours.

The following PUs were supplied;

| | Viscosity (cps) | | % Microspheres |
|---|---|---|---|
| Composition # | @ 100° C. | Open-time (min.) | (by weight) |
| A (SG 1516-188) | 27400 | 3.0-6.0 minutes | 0 |
| B (SG 1516-189) | 27800 | 3.5-6.5 minutes | 0 |
| C (SG 1516-193) | 52800 | 3.5-6.0 minutes | 6 |
| D (SG 1516-194) | 50250 | 2.0-3.0 minutes | 6 |

Viscosity was measured with a Brookfield TT-100 inline viscometer. Gauge was measured with a Cady deadweight bench micrometer, or Cady Gauge. E130-095AD microspheres manufactured by Dualite were utilized in the compressible polyurethane layer. The following blanket carcasses were made utilizing the provided compositions, and obtaining the following results:

| | | Compressible | | |
|---|---|---|---|---|
| Carcass # | Adhesive Layer | Layer | Gauge | Stress |
| 1 | A (SG 1516-188) | D (SG 1516-194) | 0.054 | 20.02 |
| 2 | B (SG 1516-189) | C (SG 1516-193) | 0.059 | 20.07 |

Additionally, carcass #1 exhibited an adhesion between the bottom-ply and the center-ply of 2.7 lbs/inch. Carcass #1 also had an adhesion between the center-ply and the top-ply of 13.1 lbs/inch.

I claim:

1. A printing blanket carcass, comprising, in order:
a fabric stack substrate comprising at least one fabric ply, each of said ply having a plurality of warp and fill fibers or yarns
a compressible layer deposed atop said substrate comprising a moisture cured thermoset polymer matrix having a plurality of closed cells distributed substantially uniformly therein such that said layer has substantially uniform compression characteristics; and
a top fabric stack deposed atop said compressible layer comprising at least one fabric ply, each of said ply having plurality of warp and fill fibers or yarns.

2. The printing blanket carcass of claim 1, wherein said compressible layer is a moisture cured single component polyurethane, polyurea, or a mixture thereof.

3. The printing blanket carcass of claim 2, wherein said closed cells are formed from microspheres having a diameter of from about 1 to about 200 microns, said microspheres being dispersed relatively uniformly throughout said compressible layer.

4. The printing blanket carcass of claim 3, wherein said microspheres are formed from a material selected from the group consisting of thermoplastic resins, thermosetting resins, ceramics, glasses, and sintered materials.

5. The printing blanket carcass of claim 3, wherein said microspheres further comprise a surface coating.

6. The printing blanket carcass of claim 5, wherein said surface coating is selected from the group consisting of talc, calcium carbonate, mica, calcium sulfate, barium sulfate, clay, silica, aluminum trihydrate, or a combination thereof.

7. The printing blanket carcass of claim 3, wherein said compressible layer contains from about 1 to about 10 wt. % microspheres.

8. The printing blanket carcass of claim 7, wherein said compressible layer contains about 6 wt. % microspheres.

9. The printing blanket carcass of claim 2, wherein said compressible layer is from about 0.02 to about 0.05 inches in thickness.

10. The printing blanket carcass of claim 9, wherein said compressible layer is about 0.24 inches in thickness.

11. The printing blanket carcass of claim 9, wherein said compressible layer is about 0.34 inches in thickness.

12. The printing blanket carcass of claim 2, wherein said carcass has a stress of from about 15 to about 25 Kg/cm² when measured at 0.23 mm.

13. The printing blanket carcass of claim 12, wherein said carcass has a stress of from about 19 to about 21 Kg/cm² when measured at 0.23 mm.

14. The printing blanket carcass of claim 2, wherein said fabric stack subtrate and said top fabric stack are nipped directly into said compressible layer, said blanket carcass lacking a separate adhesive layer between said second fabric layer and said compressible layer, and between said compressible layer and said third fabric ply.

15. The printing blanket carcass of claim 2, wherein at least one said fabric substrate stack or said top fabric stack comprises at least two fabric plies, said plies being bound together with an adhesive layer, said adhesive layer selected from the group consisting of thermoplastic resins, thermosetting resins, polyurethanes, natural elastomers, synthetic elastomers, or a combination thereof.

16. The printing blanket carcass of claim 15, wherein said adhesive layer a moisture cured single component polyurethane, polyurea, or a mixture thereof.

17. The printing blanket carcass of claim 15, wherein said adhesive layer has a plurality of closed cells distributed substantially uniformly therein such that said layer has substantially uniform compression characteristics

18. The printing blanket carcass of claim 17, wherein said closed cells are formed from microspheres having a diameter of from about 1 to about 200 microns, said microspheres being dispersed relatively uniformly throughout said compressible layer.

19. The printing blanket carcass of claim 18, wherein said microspheres are formed from a material selected from the group consisting of thermoplastic resins, thermosetting resins, ceramics, glasses, and sintered materials.

20. The printing blanket carcass of claim 18, wherein said microspheres further comprise a surface coating.

21. The printing blanket carcass of claim 20, wherein said surface coating is selected from the group consisting of talc, calcium carbonate, mica, calcium sulfate, barium sulfate, clay, silica, aluminum trihydrate, or a combination thereof.

22. The printing blanket carcass of claim 18, wherein said compressible layer contains from about 1 to about 10 wt. % microspheres.

23. The printing blanket carcass of claim 22, wherein said compressible layer contains about 6 wt. % microspheres.

24. A printing blanket, comprising, in order:
a fabric stack substrate comprising at least one fabric ply, each of said ply having a plurality of warp and fill fibers or yarns;
a compressible layer deposed atop said substrate comprising a moisture cured thermoset polymer matrix having a plurality of closed cells distributed substantially uniformly therein such that said layer has substantially uniform compression characteristics; and
a top fabric stack deposed atop said compressible layer comprising at least one fabric ply, each of said ply having plurality of warp and fill fibers or yarns;
a first adhesive compound deposed atop said top fabric stack;
a subface deposed atop said first adhesive compound, formed from a high durometer, high tensile, low elongation compound; and
an elastomeric printing face deposed atop said subface.

25. A method of manufacturing a compressible printing blanket carcass comprising the steps of:
providing a fabric stack substrate comprising at least one fabric ply, each of said ply having a plurality of warp and fill fibers or yarns;
coating said fabric stack substrate with a compressible layer comprising a thermoset polymer matrix having a plurality of closed cells distributed substantially uniformly therein such that said layer has substantially uniform compression characteristics; and
adhering a third fabric layer to said compressible layer.

26. The method of claim 25, wherein said compressible layer is a moisture cured single component polyurethane, polyurea, or a mixture thereof.

27. The method of claim 26, wherein said closed cells are formed from microspheres having a diameter of from about 1 to about 200 microns, said microspheres being dispersed relatively uniformly throughout said compressible layer.

28. The method of claim 27, wherein said microspheres are formed from a material selected from the group consisting of thermoplastic resins, thermosetting resins, ceramics, glasses, and sintered materials.

29. The method of claim 27, wherein said microspheres further comprise a surface coating.

30. The method of claim 29, wherein said surface coating is selected from the group consisting of talc, calcium carbonate, mica, calcium sulfate, barium sulfate, clay, silica, aluminum trihydrate, or a combination thereof.

31. The method of claim 27, wherein said compressible layer contains from about 1 to about 10 wt. % microspheres.

32. The method of claim 31, wherein said compressible layer contains about 6 wt. % microspheres.

33. The method of claim 26, wherein said compressible layer is coated to a thickness of from about 0.02 to about 0.05 inches.

34. The method of claim 33, wherein said compressible layer is coated to a thickness of about 0.24 inches.

35. The method of claim 33, wherein said compressible layer is coated to a thickness of about 0.34 inches.
